(19) United States
(12) Patent Application Publication
(10) Pub. No.: US 2026/0189927 A1
(43) Pub. Date: Jul. 2, 2026

(54) METHOD AND APPARATUS FOR SPECTRUM SHARING BETWEEN NETWORK TECHNOLOGIES

(71) Applicant: Huawei Technologies Co., Ltd., Shenzhen (CN)

(72) Inventors: Hao Tang, Ottawa (CA); Jianglei Ma, Ottawa (CA); Dongdong Wei, Shanghai (CN); Lei Dong, Shanghai (CN); Liqing Zhang, Ottawa (CA)

(21) Appl. No.: 19/548,857

(22) Filed: Feb. 24, 2026

Related U.S. Application Data
(63) Continuation of application No. PCT/CN2024/078514, filed on Feb. 26, 2024.

(30) Foreign Application Priority Data
Aug. 25, 2023 (WO) PCT/CN2023/114927

(51) Int. Cl. H04W 16/14

(52) U.S. Cl. CPC H04W 16/14

(57) ABSTRACT

Embodiments of the present application provide a method and apparatus for spectrum sharing between network technologies. The method includes: receiving first indication information, where the first indication information indicates a mode among multiple modes, the multiple modes include a first mode, and a first set of configurations associated with the first mode includes part or all of a second set of configurations associated with a second radio access technology; and communicating based on the first indication information.

### CROSS-REFERENCE TO RELATED APPLICATIONS

The present application is a continuation of PCT patent application No. PCT/CN2024/078514, filed on Feb. 26, 2024, which claims priority to PCT patent application No. PCT/CN2023/114927, filed on Aug. 25, 2023, both of which are hereby incorporated by reference in their entirety.

### TECHNICAL FIELD

Embodiments of the present application relate to the field of communications, and more specifically, to a method and apparatus for spectrum sharing between network technologies.

### BACKGROUND

With the emergence of a new generation of wireless communications, the new generation and old generation of wireless communications may be employed simultaneously, especially in the early stage of employment of the new generation. For example, a network device may communicate with terminal device(s) associated with a fifth generation (5G) technology (e.g. 5G user equipment (UE)) and terminal device(s) associated with a sixth generation (6G) technology (e.g. 6G UE) simultaneously. In the initial employment of a new generation technology such as 6G technology, 5G UE(s) and 5G network(s) are likely to be utilized with the 6G UE(s) and 6G network(s). Multiple spectrums have been occupied by the existing 5G technology.

Therefore, an urgent technical problem that needs to be solved is how to make multiple terminal devices associated with different technologies co-exist better.

### SUMMARY

Embodiments of the present application provide a method and apparatus for spectrum sharing between network technologies. The technical solutions may make multiple terminal devices associated with different technologies co-exist better.

According to a first aspect, an embodiment of the present application provides a communication method, and the method may be performed by a first terminal device or a chip of the first terminal device. The first terminal device is associated with a first radio access technology. The method includes: receiving first indication information, where the first indication information indicates a mode among multiple modes, the multiple modes include a first mode, and a first set of configurations associated with the first mode includes part or all of a second set of configurations associated with a second radio access technology; and communicating based on the first indication information.

According to a second aspect, an embodiment of the present application provides a communication method, and the method may be performed by a network device or a chip of the network device. The method includes: transmitting first indication information to a first terminal device associated with a first radio access technology, where the first indication information indicates a mode among multiple modes, the multiple modes include a first mode, and a first set of configurations associated with the first mode includes part or all of a second set of configurations associated with a second radio access technology; and communicating with the first terminal device based on the first indication information.

According to the above technical solution, at least part of a set of configurations could be shared between terminal device(s) associated with the first radio access technology and terminal device(s) associated with the second radio access technology. The network device could serve multiple terminal devices associated with different generations of technology with the same configurations. The multiple terminal devices associated with different generations of technology may co-exist better.

With reference to the first aspect or the second aspect, in some embodiments, the first set of configurations includes configurations of one or more of: physical resources, sequence generation and procedures.

According to the above technical solution, at least one of resources in a time-frequency domain, resources in a code domain and procedures can be shared between terminal device(s) associated with the first radio access technology and terminal device(s) associated with the second radio access technology. Thereby, the resource utilization can be improved.

With reference to the first aspect or the second aspect, in some embodiments, the first mode is associated with a first frequency band, and the first frequency band is associated with the first radio access technology and the second radio access technology.

According to the above technical solution, a frequency band can be shared between terminal device(s) associated with the first radio access technology and terminal device(s) associated with the second radio access technology, and the first terminal device can use all or part of the second radio access technology when working in the first mode. Thereby, the resource utilization can be improved.

With reference to the first aspect or the second aspect, in some embodiments, the first indication information indicates a frequency band, and the mode indicated by the first indication information is associated with the frequency band.

According to the above technical solution, the mode can be indicated by a frequency band indication, and additional specific mode indications can be omitted, which can reduce transmitting consumption.

With reference to the first aspect or the second aspect, in some embodiments, the physical resources include one or more of: physical resources mapped with physical signals or channels, and candidate physical resources configured for physical signals or channels.

For example, the candidate physical resources configured for physical signals or channels may be a control resource set.

With reference to the first aspect or the second aspect, in some embodiments, first physical resources associated with the first set of configurations include part or all of second physical resources associated with the second set of configurations.

According to the above technical solution, at least part of the same physical resources can be shared between terminal device(s) associated with the first radio access technology and terminal device(s) associated with the second radio access technology. Thereby, the physical resource utilization can be improved.

With reference to the first aspect or the second aspect, in some embodiments, the first physical resources are a subset of the second physical resources, or the second physical resources are a subset of the first physical resources.

According to the above technical solution, when the first physical resources are a subset of the second physical resources, the first terminal device may get better performance for a greater size of the first physical resources. When the second physical resources are a subset of the first physical resources, the first terminal device may save more power for a smaller size of the first physical resources.

With reference to the first aspect or the second aspect, in some embodiments, the configurations of the sequence generation indicate one or more codes used for physical signals or channels.

For example, the configurations of the sequence generation indicate one or more code division multiplexing (CDM) groups. Thereby, at least part of code resources can be shared between terminal device(s) associated with the first radio access technology and terminal device(s) associated with the second radio access technology. Thereby, the code resource utilization can be improved.

With reference to the first aspect or the second aspect, in some embodiments, the multiple modes include a second mode, and a set of configurations associated with the second mode is dedicated to the first radio access technology.

With reference to the first aspect or the second aspect, in some embodiments, the multiple modes include a third mode, and a third set of configurations associated with the third mode include part of the second set of configurations.

According to the above technical solution, the first terminal device may support two or more modes. Thereby, the first terminal device can work flexibly.

With reference to the first aspect, in some embodiments, the method further includes: receiving second indication information, where the second indication information indicates one or more resource elements for data communication, and the one or more resource elements are located in a control resource set.

With reference to the second aspect, in some embodiments, the method further includes: transmitting second indication information, where the second indication information indicates one or more resource elements for data communication, and the one or more resource elements are located in a control resource set.

According to the above technical solution, unoccupied resources in the control resource set can be used by the first terminal device. Thereby, the resource utilization can be further improved.

With reference to the first aspect or the second aspect, in some embodiments, the control resource set is associated with the second radio access technology.

According to the above technical solution, unoccupied resources in the control resource set associated with the second radio access technology can be used by the first terminal device. Thereby, the resource utilization can be further improved.

With reference to the first aspect, in some embodiments, the method further includes: receiving third indication information, where the third indication information indicates a set of configurations associated with the mode indicated by the first indication information.

With reference to the second aspect, in some embodiments, the method further includes: transmitting third indication information, where the third indication information indicates a set of configurations associated with the mode indicated by the first indication information.

According to the above technical solution, the network device could indicate the set of configurations to the first terminal device, and the resource configuration can be flexible.

With reference to the first aspect or the second aspect, in some embodiments, the first indication information further indicates the first terminal device to transition from a fourth mode, and power consumption corresponding to the fourth mode is lower than power consumption corresponding to the mode indicated by the first indication information.

According to the above technical solution, the first indication information may indicate the first terminal device to transition from a power saving mode to the indicated mode.

With reference to the first aspect or the second aspect, in some embodiments, the second radio access technology is a fifth generation (5G) radio access technology, and the first radio access technology is a sixth generation (6G) radio access technology.

According to a third aspect, a terminal device is provided. The terminal device includes a function or unit configured to perform the method according to the first aspect or any one of the possible embodiments of the first aspect.

According to a fourth aspect, a network device is provided. The network device includes a function or unit configured to perform the method according to the second aspect or any one of the possible embodiments of the second aspect.

According to a fifth aspect, a system is provided. The system includes: the terminal device according to the third aspect and the network device according to the fourth aspect.

According to a sixth aspect, a communication apparatus is provided. The communication apparatus includes at least one processor, and the at least one processor is coupled to at least one memory. The at least one memory is configured to store a computer program or one or more instructions. The at least one processor is configured to: invoke the computer program or the one or more instructions from the at least one memory and run the computer program or the one or more instructions, so that the communication apparatus performs the method in any one of the first aspect or the possible implementations of the first aspect, or the communication apparatus performs the method in any one of the second aspect or the possible implementations of the second aspect.

With reference to the sixth aspect, in some implementations of the sixth aspect, the communication apparatus may be a network device or a component (for example, a chip or an integrated circuit) installed in the network device. For another example, the communication apparatus may be a terminal device or a component (for example, a chip or an integrated circuit) installed in the terminal device.

With reference to the sixth aspect, in some implementations of the sixth aspect, the communication apparatus may be a terminal device or a component (for example, a chip or an integrated circuit) installed in the terminal device. For another example, the communication apparatus may be a network device or a component (for example, a chip or an integrated circuit) installed in the network device.

According to a seventh aspect, a communication apparatus is provided. The communication apparatus includes a processor and a communications interface. The processor is connected to the communications interface. The processor is configured to execute one or more instructions, and the communications interface is configured to communicate with other network elements under the control of the processor. The processor is enabled to perform the method according to the first aspect, any one of the possible embodiments of the first aspect, the second aspect, or any one of the possible embodiments of the second aspect.

According to an eighth aspect, a computer storage medium is provided. The computer storage medium stores program code, and the program code is used to execute one or more instructions for the method according to the first aspect, any one of the possible embodiments of the first aspect, the second aspect, or any one of the possible embodiments of the second aspect.

According to a ninth aspect, this application provides a computer program product including one or more instructions, where when the computer program product runs on a computer, the computer performs the method according to the first aspect, any one of the possible embodiments of the first aspect, the second aspect, or any one of the possible embodiments of the second aspect.

According to a tenth aspect, this application provides a non-transitory computer-readable medium storing instruction the instructions causing a processor in a device to implement the method according to the first aspect or any one of the possible embodiments of the first aspect, or the second aspect or any one of the possible embodiments of the second aspect.

According to an eleventh aspect, this application provides a device configured to perform the method according to the first aspect or any one of the possible embodiments of the first aspect, or the second aspect or any one of the possible embodiments of the second aspect.

According to a twelfth aspect, this application provides a processor, configured to execute instructions to cause a device to perform the method according to the first aspect or any one of the possible embodiments of the first aspect, or the second aspect or any one of the possible embodiments of the second aspect.

According to a thirteenth aspect, this application provides an integrated circuit configure to perform the method according to the first aspect or any one of the possible embodiments of the first aspect, or the second aspect or any one of the possible embodiments of the second aspect.

According to a fourteenth aspect, this application provides a communication apparatus, comprising a transceiver unit, configured to perform the receiving step according to the first aspect or any one of the possible embodiments of the first aspect, and a processing unit, configured to perform the processing step according to the first aspect or any one of the possible embodiments of the first aspect.

According to a fifteenth aspect, this application provides a communication apparatus, comprising a transceiver unit, configured to perform the transmitting step according to the second aspect or any one of the possible embodiments of the second aspect.

### DESCRIPTION OF THE DRAWINGS

FIG. 1 is a schematic diagram of an application scenario according to this application;

FIG. 2 illustrates an example communications system 100;

FIG. 3 illustrates another example of an ED and a base station;

FIG. 4 illustrates units or modules in a device;

FIG. 5 illustrates a first embodiment of spectrum sharing between two technologies;

FIG. 6 illustrates a second embodiment of spectrum sharing between two technologies;

FIG. 7 illustrates a third embodiment of spectrum sharing between two technologies;

FIG. 8 illustrates a schematic flowchart of a communication method;

FIG. 9 is a schematic flowchart of a communication method according to an embodiment of this application;

FIG. 10 illustrates a first example of 6G physical resources and 5G physical resources according to an embodiment of this application;

FIG. 11 illustrates a second example of 6G physical resources and 5G physical resources according to an embodiment of this application;

FIG. 12 illustrates a third example of 6G physical resources and 5G physical resources according to an embodiment of this application;

FIG. 13 illustrates a fourth example of 6G physical resources and 5G physical resources according to an embodiment of this application;

FIG. 14 illustrates a fifth example of 6G physical resources and 5G physical resources according to an embodiment of this application;

FIG. 15 illustrates a schematic diagram of periodic SRS resources according to an embodiment of this application;

FIG. 16 illustrates a schematic diagram of 6G configurations in a spatial domain according to an embodiment of this application;

FIG. 17 illustrates a schematic diagram of indicating a first mode or a second mode according to an embodiment of this application;

FIG. 18 illustrates a schematic diagram of a 6G SS/PBCH block corresponding to a 5G-like mode according to an embodiment of this application;

FIG. 19 illustrates a schematic diagram of a 6G SS/PBCH block corresponding to a 6G-pure mode according to an embodiment of this application;

FIG. 20 illustrates a first schematic diagram of CSI-RS corresponding to a 5G-enhanced mode according to an embodiment of this application;

FIG. 21 illustrates a second schematic diagram of CSI-RS corresponding to a 5G-enhanced mode according to an embodiment of this application;

FIG. 22 illustrates a schematic diagram of SRS corresponding to a 5G-enhanced mode according to an embodiment of this application;

FIG. 23 illustrates a schematic diagram of DMRS corresponding to a 5G-enhanced mode according to an embodiment of this application; and

FIGS. 24 and 25 are schematic block diagrams of possible devices according to embodiments of this application.

### DETAILED DESCRIPTION OF THE ILLUSTRATIVE EMBODIMENTS

The following describes technical solutions of the present application with reference to the accompanying drawings.

The technical solutions in embodiments of this application may be applied to various communications systems, such as a Global System for Mobile Communications (GSM), a Code Division Multiple Access (CDMA) system, a Wideband Code Division Multiple Access (WCDMA) system, a general packet radio service (GPRS) system, a Long Term Evolution (LTE) system, an LTE frequency division duplex (FDD) system, an LTE time division duplex (TDD) system, a Universal Mobile Telecommunications System (UMTS), a Worldwide Interoperability for Microwave Access (WiMAX) communications system, a wireless local area network (WLAN), a fifth generation (5G) wireless communications system, a new ratio (NR) wireless communications system, a sixth generation (6G) wireless communications system, or other evolving communications systems.

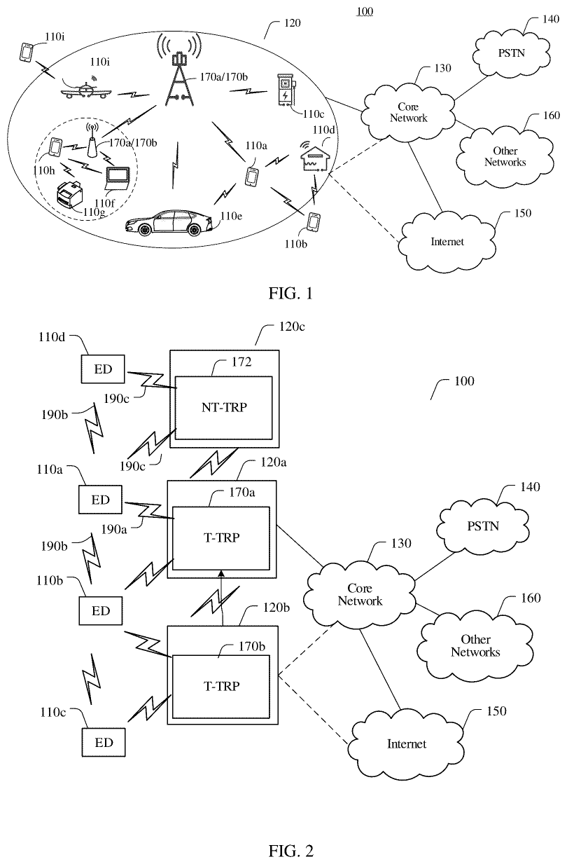

For ease of understanding the embodiments of this application, a communications system shown in FIGS. 1-3 is first used as an example to describe in detail a communications system to which the embodiments of this application are applicable.

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

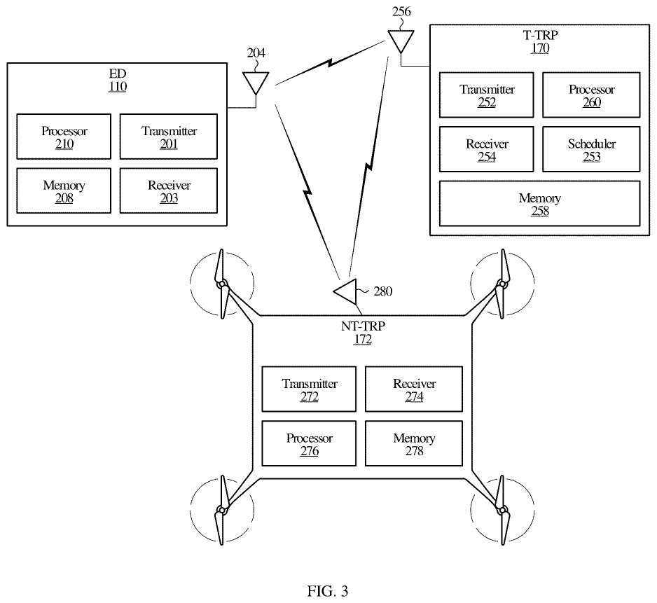

FIG. 3 illustrates another example of an ED no and a base station 170a, 170b and/or 170c. The ED no is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some embodiments, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), radio unit (RU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

The CU (or CU-control plane (CP) and CU-user plane (UP)), DU or RU may be known by other names in some embodiments. For example, in open RAN (ORAN) system, the CU may also be referred to as open CU (O-CU), DU may also be referred to as open DU (O-DU), CU-CP may also be referred to open CU-CP (O-CU-CP), CU-UP may also be referred to as open CU-UP (O-CU-CP), and RU may also be referred to open RU (0-RU). Any one of the CU (or CU-CP, CU-UP), DU, or RU could be implemented through a software module, a hardware module, or a combination of software and hardware modules.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some embodiments, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

For ease of understanding the embodiments of this application, the following briefly describes a process of transmitting reference signals and measuring channels based on the reference signals.

Multiple input multiple-output (MIMO) technology allows an antenna array of multiple antennas to perform signal transmissions and receptions to meet high transmission rate requirements. The above ED110 and T-TRP 170, and/or NT-TRP use MIMO to communicate over the wireless resource blocks. MIMO utilizes multiple antennas at the transmitter and/or receiver to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained wide attentions from the academia and the industry. In the large-scale MIMO system, the T-TRP 170, and/or NT-TRP 172 is generally configured with more than ten antenna units (such as 128 or 256), and serves dozens of the ED 110 (such as 40). A large number of antenna units of the T-TRP 170, and NT-TRP 172 can greatly increase the degree of spatial freedom of wireless communication, greatly improve the transmission rate, spectrum efficiency and power efficiency, and eliminate the interference between cells to a large extent. The increased number of antennas allows each antenna unit to be smaller in size with a lower cost. Using the degree of spatial freedom provided by the large-scale antenna units, the T-TRP 170, and NT-TRP 172 of each cell can communicate with many ED 110 in the cell on the same time-frequency resource at the same time, thus greatly increasing the spectrum efficiency. A large number of antenna units of the T-TRP 170, and/or NT-TRP 172 also enable each user to have better spatial directivity for uplink and downlink transmission, so that the transmitting power of the T-TRP 170, and/or NT-TRP 172 and an ED 110 is reduced, and the power efficiency is increased. When the antenna number of the T-TRP 170, and/or NT-TRP 172 is sufficiently large, random channels between each ED 110 and the T-TRP 170, and/or NT-TRP 172 can approach orthogonal, and the interference between the cell and the users and the effect of noises can be eliminated. The plurality of advantages described above enable large-scale MIMO systems to have good prospects for application.

A MIMO system may include a receiver connected to a receive (Rx) antenna, a transmitter connected to transmit (Tx) antenna, and a signal processor connected to the transmitter and the receiver. Each of the Rx antenna and the Tx antenna may include a plurality of antennas. For instance, the Rx antenna may have an ULA antenna array in which the plurality of antennas are arranged in line at even intervals. When a radio frequency (RF) signal is transmitted through the Tx antenna, the Rx antenna may receive a signal reflected and returned from a forward target.

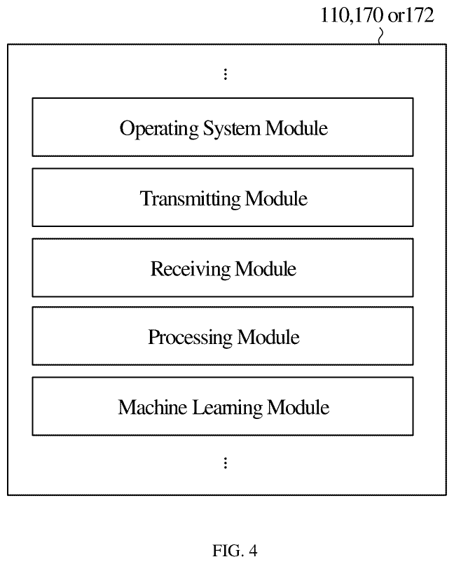

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).

A frame structure component may specify a configuration of a frame or group of frames. The frame structure component may indicate one or more of a time, frequency, pilot signature, code, or other parameter of the frame or group of frames. More details of frame structure will be discussed below.

A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:
(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.
(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. multi-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (e.g. base station) dynamically, e.g. in physical layer control signaling such as DCI, or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

In current networks, frame timing and synchronization is established based on synchronization signals, such as a primary synchronization signal (PSS) and a secondary synchronization signal (SSS). Notably, known frame timing and synchronization strategies involve adding a timestamp, e.g., (xx0:yy0:zz), to a frame boundary, where xx0, yy0, zz in the timestamp may represent a time format such as hour, minute, and second, respectively.

It is anticipated that diverse applications and use cases in future networks may involve usage of different periods of frames, slots and symbols to satisfy the different requirements, functionalities and Quality of Service (QoS) types. It follows that usage of different periods of frames to satisfy these applications may present challenges for frame timing alignment among diverse frame structures. Consider, for example, frame timing alignment for a TDD configuration in neighboring carrier frequency bands or among sub-bands (or bandwidth parts) of one channel/carrier bandwidth.

The present disclosure relates, generally, to mobile, wireless communication and, in particular embodiments, to a frame timing alignment/realignment, where the frame timing alignment/realignment may comprise a timing alignment/realignment in terms of a boundary of a symbol, a slot or a sub-frame within a frame; or a frame (thus the frame timing alignment/realignment here is more general, not limiting to the cases where a timing alignment/realignment is from a frame boundary only). Also, in this application, relative timing to a frame or frame boundary should be interpreted in a more general sense, i.e., the frame boundary means a timing point of a frame element with the frame such as (starting or ending of) a symbol, a slot or subframe within a frame, or a frame. In the following, the phrases “(frame) timing alignment or timing realignment” and “relative timing to a frame boundary” are used in more general sense described in above.

In overview, aspects of the present application relate to a network device, such as a base station 170, referenced hereinafter as a TRP 170, transmitting signaling that carries a timing realignment indication message. The timing realignment indication message includes information allowing a receiving UE 110 to determine a timing reference point. On the basis of the timing reference point, transmission of frames, by the UE 110, may be aligned. In some aspects of the present application, the frames that become aligned are in different sub-bands of one carrier frequency band. In other aspects of the present application, the frames that become aligned are found in neighboring carrier frequency bands.

On the TRP 170 side, aspects of the present application relate to use of one or more types of signaling to indicate the timing realignment (or/and timing correction) message. Two example types of signaling are provided here to show the schemes. The first example type of signaling may be referenced as cell-specific signaling, examples of which include group common signaling and broadcast signaling. The second example type of signaling may be referenced as UE-specific signaling. One of these two types of signaling or a combination of the two types of signaling may be used to transmit a timing realignment indication message. The timing realignment indication message may be shown to notify one or more UEs 110 of a configuration of a timing reference point. References, hereinafter, to the term “UE 110” may be understood to represent reference to a broad class of generic wireless communication devices within a cell (i.e., a network receiving node, such as a wireless device, a sensor, a gateway, a router, etc.), that is, being served by the TRP 170. A timing reference point is a timing reference instant and may be expressed in terms of a relative timing, in view of a timing point in a frame, such as (starting or ending boundary of) a symbol, a slot or a sub-frame within a frame; or a frame. For a simple description in the following, the term “a frame boundary” is used to represent a boundary of possibly a symbol, a slot or a sub-frame within a frame; or a frame. Thus, the timing reference point may be expressed in terms of a relative timing, in view of a current frame boundary, e.g., the start of the current frame. Alternatively, the timing reference point may be expressed in terms of an absolute timing based on certain standards timing reference such as a GNSS (e.g., GPS), Coordinated Universal Time (“UTC”), etc. In the absolute timing version of the timing reference point, a timing reference point may be explicitly stated.

The timing reference point may be shown to allow for timing adjustments to be implemented at the UEs 110. The timing adjustments may be implemented for improvement of accuracy for a clock at the UE 110. Alternatively, or additionally, the timing reference point may be shown to allow for adjustments to be implemented in future transmissions made from the UEs 110. The adjustments may be shown to cause realignment of transmitted frames at the timing reference point. Note that the realignment of transmitted frames at the timing reference point may comprise the timing realignment from (the starting boundary of) a symbol, a slot or a sub-frame within a frame; or a frame at the timing reference point for one or more UEs and one or more BSs (in a cell or a group of cells), which applies across the application below.

At UE 110 side, the UE 110 may monitor for the timing realignment indication message. Responsive to receiving the timing realignment indication message, the UE 110 may obtain the timing reference point and take steps to cause frame realignment at the timing reference point. Those steps may, for example, include commencing transmission of a subsequent frame at the timing reference point.

Furthermore, or alternatively, before monitoring for the timing realignment indication message, the UE 110 may cause the TRP 170 to transmit the timing realignment indication message by transmitting, to the TRP 170, a request for a timing realignment, that is, a timing realignment request message. Responsive to receiving the timing realignment request message, the TRP 170 may transmit, to the UE 110, a timing realignment indication message including information on a timing reference point, thereby allowing the UE 110 to implement a timing realignment (or/and a timing adjustment including clock timing error correction), wherein the timing realignment is in terms of (e.g., a starting boundary of) a symbol, a slot or a sub-frame within a frame; or a frame for UEs and base station(s) in a cell (or a group of cells).

According to aspects of the present application, a TRP 170 associated with a given cell may transmit a timing realignment indication message. The timing realignment indication message may include enough information to allow a receiver of the message to obtain a timing reference point. The timing reference point may be used, by one or more UEs 110 in the given cell, when performing a timing realignment (or/and a timing adjustment including clock timing error correction).

According to aspects of the present application, the timing reference point may be expressed, within the timing realignment indication message, relative to a frame boundary (where, as previously described and to be applicable below across the application, a frame boundary can be a boundary of a symbol, a slot or a sub-frame with a frame; or a frame). The timing realignment indication message may include a relative timing indication, Δt. It may be shown that the relative timing indication, Δt, expresses the timing reference point as occurring a particular duration, i.e., Δt, subsequent to a frame boundary for a given frame. Since the frame boundary is important to allowing the UE 110 to determine the timing reference point, it is important that the UE 110 be aware of the given frame that has the frame boundary of interest. Accordingly, the timing realignment indication message may also include a system frame number (SFN) for the given frame.

It is known, in 5G NR, that the SFN is a value in range from 0 to 1023, inclusive. Accordingly, 10 bits may be used to represent an SFN. When an SFN is carried by an SSB, six of the 10 bits for the SFN may be carried in a Master Information Block (MIB) and the remaining four bits of the 10 bits for the SFN may be carried in a Physical Broadcast Channel (PBCH) payload.

Optionally, the timing realignment indication message may include other parameters. The other parameters may, for example, include a minimum time offset. The minimum time offset may establish a duration of time preceding the timing reference point. The UE 110 may rely upon the minimum time offset as an indication that DL signaling, including the timing realignment indication message, will allow the UE 110 enough time to detect the timing realignment indication message to obtain information on the timing reference point.

Embodiments of this application can be applied to any communication scenario where a network device (e.g. T-TRP or NT-TRP) communicates with one or more terminal devices (e.g. ED). With the emergence of a new generation of wireless communications, the new generation and old generation of wireless communications may be employed simultaneously, especially in the early stage of employment of a new generation. For example, a network device may communicate with terminal device(s) associated with a 5G technology (e.g. 5G UE) and terminal device(s) associated with a 6G technology (e.g. 6G UE) simultaneously. For ease of understanding of this application, the following embodiments are illustrative of a network device communicating with a first terminal device (e.g. 6G UE), and the network device may communicate with a second terminal device (e.g. 5G UE) alternatively.

In the initial employment of the new generation technology, such as the 6G technology, 5G UE(s) and 5G network(s) are likely to be employed with the 6G UE(s) and 6G network(s). Multiple spectrums have been occupied by the existing 5G technology. In order to improve the spectrum coverage of the new generation technology, it is important to design spectrum sharing between multiple generations of technology.

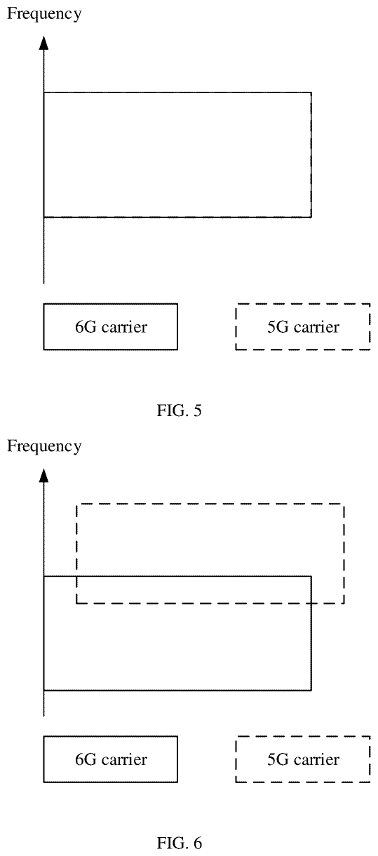

Spectrum sharing implies that multiple radio access technologies could share the same spectrum. That is, there is a spectrum that multiple types of UEs (e.g. 5G UE and 6G UE) can use to transmit channels or signals. For example, one or more carriers can be allocated to 5G UE(s) to transmit channels and signals and can be named as 5G carrier(s). One or more carriers can be allocated to 6G UE(s) to transmit channels or signals and can be named as 6G carrier(s). The 5G carrier(s) and 6G carrier(s) may overlap partially or fully. For ease of understanding the embodiments of this application, three cases of spectrum sharing between 5G technology (UE(s)) and 6G technology (UE(s)) are shown in FIGS. 5-7.

FIG. 5 illustrates a first embodiment of spectrum sharing between two technologies, for example 5G technology (5G UE(s)) and 6G technology (6G UE(s)). As shown in FIG. 5, a 6G carrier can overlap fully with a 5G carrier. In other words, the 5G carrier and 6G carrier can be located in a same frequency. The 6G UE(s) could reuse all of the 5G carrier.

FIG. 6 illustrates a second embodiment of spectrum sharing between two technologies, for example 5G technology (5G UE(s)) and 6G technology (6G UE(s)). As shown in FIG. 6, a 6G carrier can overlap partially with a 5G carrier. In other words, 6G UE(s) could reuse part of the 5G carrier.

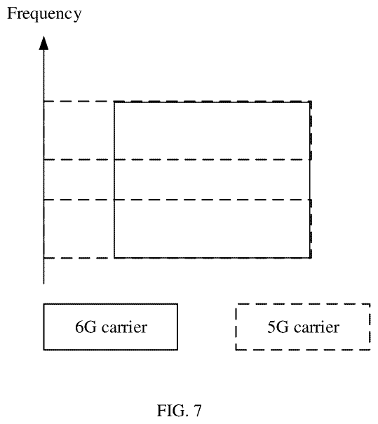

FIG. 7 illustrates a third embodiment of spectrum sharing between two technologies, for example 5G technology (5G UE(s)) and 6G technology (6G UE(s)). As shown in FIG. 7, a 6G carrier can overlap with two 5G carriers (e.g. 5G carrier 1 and 5G carrier 2). In other words, 6G UE(s) could reuse part or all of multiple 5G carriers.

In some embodiments, spectrum sharing could be implemented in a static manner or a dynamic manner. The shared spectrum may include multiple carriers, and a carrier in the shared spectrum is for which technology is dedicated when the static manner is implemented. The dynamic spectrum sharing (DSS) implies that multiple radio access technologies share the same spectrum, but how much of the spectrum is allocated to which radio access technology (5G or 6G) may be not fixed.

In 4G-5G DSS, frequency division multiplexing (FDM) and time division multiplexing (TDM) are supported, which can reduce conflict between the 4G UE(s) and 5G UE(s). However, 4G UE(s) and 5G UE(s) occupy a lot of resources to transmit channels and signals respectively.

Therefore, this application provides a communication method in which UEs associated with different generations of technologies can use at least part of the same configurations to transmit channel(s) or signal(s), to make multiple terminal devices associated with different generations co-exist better.

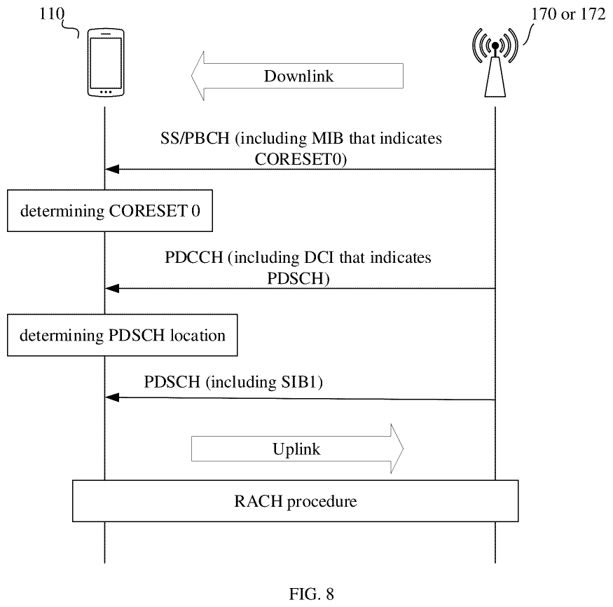

For ease of understanding the various types of signals, channels and information that will be presented in embodiments of this application, an illustrative figure, FIG. 8, is used to illustrate simple signaling interaction between the network device and the terminal device.

Referring to FIG. 8, the term “downlink” is used to denote the direction from the network device (170,172) to the terminal device (110), and the term “uplink” is used to denote the direction from the terminal device (110) to the network device (170,172). When terminal device (110) is turned on, the terminal device detects an SS/PBCH block from the network device (170,172), where the SS/PBCH block could be used for downlink synchronization. In addition, the SS/PBCH block includes master information block (MIB), where the MIB can be used to (but not limited to) indicate a control resource set 0 (CORESET 0). The CORESET 0 includes resources in time-frequency domain for PDCCH, and the PDCCH could carry downlink control information (DCI), where the DCI indicates a location of a PDSCH. That is, the terminal device (110) can receive a PDCCH including DCI that indicates a PDSCH based on the SS/PBCH block, and receive the PDSCH based on the received PDCCH. The PDSCH includes system information block type 1 (SIB1), and the SIB1 can be used for the subsequent interaction, for example radio access channel procedure.

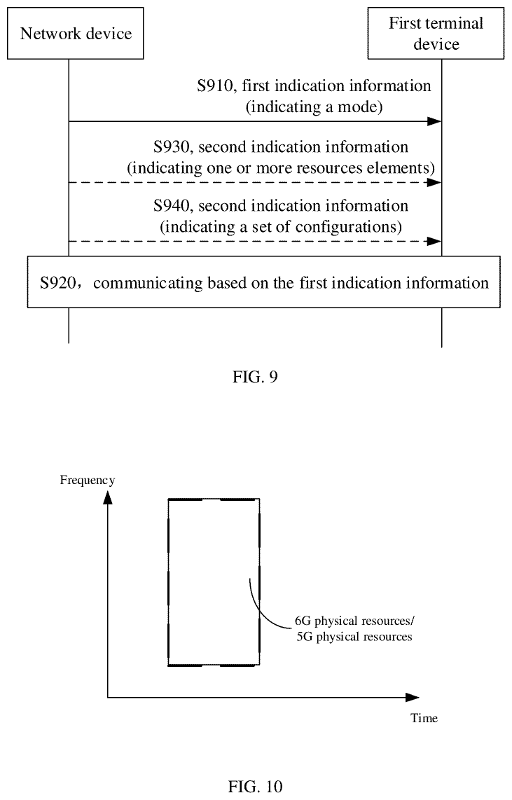

FIG. 9 is a schematic flowchart of a communication method according to an embodiment of this application. The communication method may be applied to the communications system described above.

At S910, a network device transmits first indication information to a first terminal device. Correspondingly, the first terminal device receives the first indication information from the network device.

At S920, the first terminal device communicates with the network device based on the first indication information.

The first indication information may indicate a mode among multiple modes, the multiple modes include a first mode, and a first set of configurations associated with the first mode includes part or all of a second set of configurations associated with a second radio access technology. That is, at least part of a set of configurations could be shared between terminal device(s) associated with the first radio access technology and terminal device(s) associated with the second radio access technology. The network device could serve multiple terminal devices associated with different technologies with the same configurations. The multiple terminal devices associated with different technologies may co-exist better.

A mode may comprise a set of configurations that may be used by a device to communicate or operate. In a mode, a device (e.g., a terminal device) could use one or more radio access technologies associated with this mode to communicate or operate. In other words, in a mode, the device could use one or more sets of configurations associated with this mode to communicate or operate.

The first terminal device may be associated with a first radio access technology. In some embodiments, the first radio access technology and the second radio access technology are two generations of radio access technology. For example, the first radio access technology corresponds to the 6G technology, and the second radio access technology corresponds to the 5G technology. A 6G UE may be an example of the first terminal device and a 5G UE may be an example of the second terminal device in embodiments below. The network device can serve both the 5G UE(s) and the 6G UE(s).

It is noted that embodiments of this application take 5G technology and 6G technology as examples. The first terminal device may be associated with another technology. The first part may be shared among terminal devices associated with three or more kinds of technology. This is not limited in this application.

It is noted that the “first mode” is only named for differentiation and does not limit the scope of protection of the embodiments of this application. Similarly, a “second mode”, and a “first terminal device”, etc. in the following description are also only named for differentiation and do not limit the scope of protection of the embodiments of this application, and this will not be repeated below.

The first set of configurations may be for one or more of physical signals and physical channels. Uplink physical channels may include one or more of a physical uplink shared channel (PUSCH), a physical uplink control channel (PUCCH), a physical random access channel (PRACH). Uplink physical signals may include one or more of demodulation reference signals (DM-RS) and sounding reference signals (SRS). Downlink physical channels may include one or more of a physical downlink shared channel, a physical broadcast channel (PBCH), a physical downlink shared channel (PDSCH) and a physical downlink control channel (PDCCH). Downlink physical signals may include one or more of: demodulation reference signals (DM-RS), positioning reference signals (PRS), channel-state information reference signals (CSI-RS), primary synchronization signals (PSS) and secondary synchronization signals (SSS).

A set of configurations may include one or more of: configurations of physical resources, configurations of sequence generation and configurations of procedures. The first set of configurations includes part or all of the second set of configurations in a time-frequency domain and/or code domain. The embodiments will be described hereinafter.

In some embodiments, first physical resources associated with the first set of configurations include part or all of second physical resources associated with the second set of configurations. The first physical resources and the second physical resources may be the time-frequency resources occupied by signal(s) or channel(s). For example, at least part of signal(s) or channel(s) (e.g. SSS, PSS, PRACH, DMRS, CSI-RS, SRS, PUCCH, etc.) serving for 5G UE(s) and 6G UE(s) could be mapped to the same physical resources, and the resource utilization can be improved. Alternatively, the first physical resources and the second physical resources may be candidate physical resources of a resource set configured for signal(s) or channel(s). For example, a control resource set (CORESET) may be predefined or indicated to both 5G PDCCH and 6G PDCCH, and the 6G UE may use the unused physical resources (i.e. unused by 5G PDCCH) in the CORESET for 6G PDCCH reception. For another example, two or more SRS combs (e.g. SRS comb #1 and SRS comb #2) may be predefined or indicated to both 5G SRS and 6G SRS, the 5G UE may use one SRS comb (e.g. SRS comb #1), and the 6G UE may use the unused SRS comb (e.g. SRS comb #2). The finer rate matching pattern can improve spectrum utilization efficiency.

The first set of configurations in embodiments of this application may be one of types of 6G configurations. Physical resources associated with any one of types of the 6G configurations will be referred to as 6G physical resources hereinafter. The second set of configurations in embodiments of this application may be one of types of 5G configurations. Physical resources associated with any one of types of the 5G configurations will be referred to as 5G physical resources hereinafter.

For ease of understanding of embodiments of this application, possible configurations for 6G physical resources combined with 5G physical resources are given below.

As shown in FIG. 10, 6G physical resources and 5G physical resources may overlap completely in the time-frequency domain. The 6G physical resources include all of the 5G physical resources. The physical resources could be shared with 5G UE(s) and 6G UE(s). That is, the physical resources can serve 5G UE(s) and 6G UE(s) simultaneously. Thereby, the resource utilization can be improved.

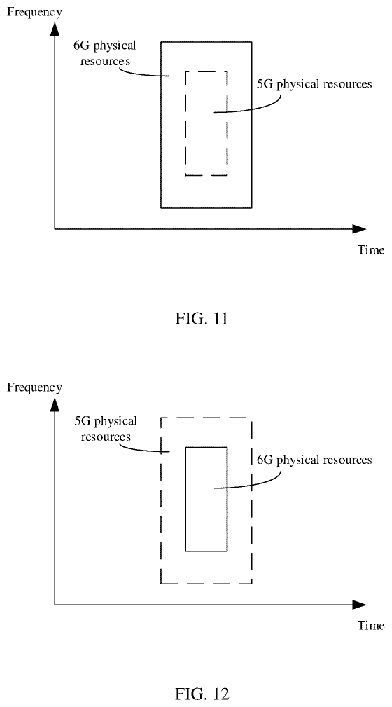

As shown in FIG. 11, 5G physical resources may be nested within 6G physical resources. That is, the 5G physical resources may be a subset of the 6G physical resources. A size of the 6G physical resources is greater than a size of the 5G physical resources, thereby, the 6G UE may get better performance compared to the 5G UE.

As shown in FIG. 12, 6G physical resources may be nested within 5G physical resources. That is, the 6G physical resources may be a subset of the 5G physical resources. A size of the 6G physical resources is smaller than a size of the 5G physical resources, thereby, the 6G UE may save more power compared to the 5G UE.

In some embodiments, 6G physical resources may not overlap with 5G physical resources.

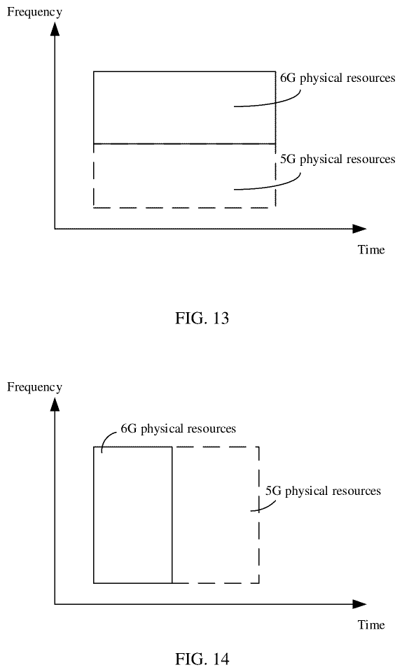

As shown in FIG. 13, the 6G physical resources are frequency division multiplexed (FDM) with the 5G physical resources. The 6G physical resources may be higher than the 5G physical resources in a frequency domain. Although not illustrated, the 6G physical resources may be lower than the 5G physical resources in the frequency domain. This is not limited in this application.

As shown in FIG. 14, the 6G physical resources may be time division multiplexed (TDM) with the 5G physical resources. The 5G physical resources may be later than the 6G physical resources in a time domain. Although not illustrated, the 6G physical resources may be later than the 5G physical resources in the time domain. This is not limited in this application.

It is noted that the above physical resources can be replaced with candidate physical resources, e.g. CORESET. 5G UE(s) and 6G UE(s) could share the CORESET, and they could rate match physical resources of the CORESET to reduce the interference between the 5G UE(s) and 6G UE(s).

It is noted that, when 5G physical resources are a subset of 6G physical resources, the 6G physical resources may include a shared part (i.e. the physical resources overlapped with the 5G physical resources) and a dedicated part. The dedicated part could be dedicated to the 6G technology.

It is noted that, when 6G physical resources are a subset of 5G physical resources, the 5G physical resources may be shared by one or more 6G UEs. For example, the 5G physical resources may include a subset #1 and a subset #2, where the subset #1 may be associated with a 6G UE #1 and the subset #2 may be associated with a 6G UE #2.

The above embodiments are only for illustrative purposes, and a size of physical resources and a location of physical resources are not limited in this application. For example, when 5G physical resources and 6G physical resources are periodic physical resources, the 5G physical resources may overlap with the 6G physical resources in all or part of 5G or 6G periods.

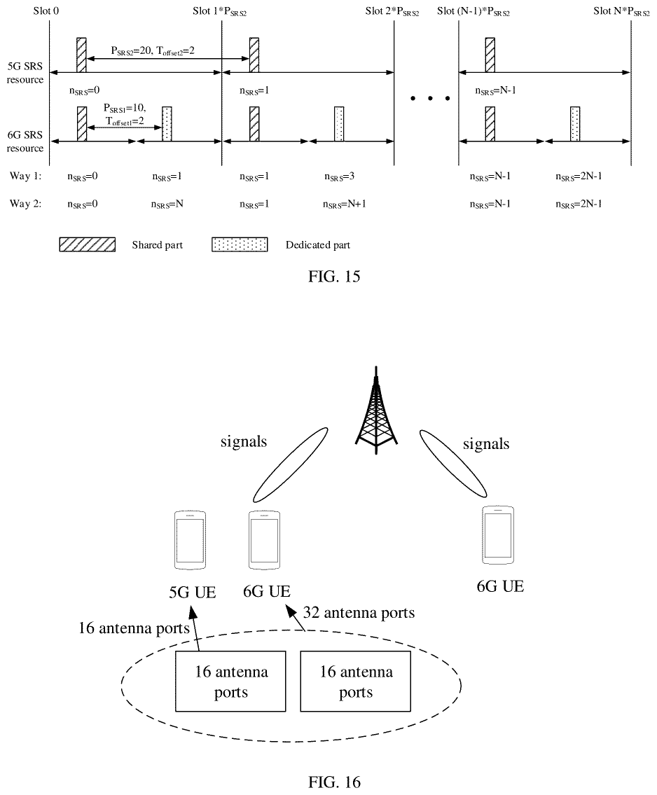

For example, FIG. 15 illustrates a schematic diagram of periodic SRS resources. The periodicity of the first SRS resource may be represented by P_{SRS1}, the timing offset of the first SRS resource may be represented by T_{offset1}, the periodicity of the second SRS resource may be represented by P_{SRS2}, and the timing offset of the second SRS resource may be represented by T_{offset2}. The SRS counter of the first SRS resource may be represented by n_{SRS1}, and the SRS counter of the second SRS resource may be represented by n_{SRS2}. The 5G SRS resource may be part of the 6G SRS resource. The 6G SRS resource may include a shared part (i.e. the 5G SRS resource) and a dedicated part. This case can be referred to as an embodiment of a nested structure.

Although not illustrated, a nested structure that 6G physical resources is a subset of 5G physical resources may be configured by a periodicity and a timing offset, and this is omitted for brevity.

In some embodiments, one or more antenna ports associated with the 6G physical resources include part or all of one or more antenna ports associated with the 5G physical resources. A time-frequency resource set may be associated with an antenna port. For example, the 6G physical resources may be part of the 5G physical resources, and antenna ports associated with the 6G physical resources may be part of the antenna ports associated with the 5G physical resources. The 5G physical resources may be part of the 6G physical resources, and antenna ports associated with the 5G physical resources may be part of the antenna ports associated with the 6G physical resources

For example, FIG. 16 illustrates a schematic diagram of 6G configurations in a spatial domain. 32 antenna ports may be associated with the 6G physical resources, and 16 antenna ports of the 32 antenna ports may be shared between the 6G UE(s) and the 5G UE(s). The other 16 antenna ports of the 32 antenna ports may be dedicated to the 6G UE(s).

Although not illustrated, the antenna ports associated with the 6G physical resources may be the part of the antenna ports associated with the 5G physical resources. For example, 16 antenna ports may be associated with the 5G physical resources, and 8 antenna ports of the 16 antenna ports may be shared between the 6G UE(s) and the 5G UE(s).

The above embodiments about the types of the 6G physical resources are for illustrative purposes.

For ease of description, a sequence generated based on a 6G set of configurations will be referred to as a 6G sequence hereinafter. A sequence generated based on a 5G set of configurations will be referred to as a 5G sequence hereinafter. The configurations of the sequence generation may indicate one or more codes used for physical signals or channels.

The 5G sequence may be code division multiplexed (CDM) with the 6G sequence. For example, when the 6G physical resources and the 5G physical resources overlap completely in the time-frequency domain (as shown in FIG. 10), the 6G sequence mapped in the 6G physical resources may be CDM with the 5G sequence mapped in the 5G physical resources.

In some embodiments, a CDM group may be indicated or predefined to both 5G UE(s) and 6G UE(s), where any two codes in the CDM group are multiplexed. A 6G UE may use the unused code (i.e. unused by 5G UE(s)) in the CDM group.

Configurations for sequence generation may include one or more of parameters: length of a sequence, a root sequence (or a base sequence) and a type of a sequence. In some embodiments, the 5G sequence and the 6G sequence may differ in one or more of the above parameters.

For ease of description, a transmission procedure determined based on the 6G set of configurations will be referred to as a 6G transmission procedure hereinafter. A transmission procedure determined based on the 5G set of configurations may be described as a 5G transmission procedure.

In some embodiments, the 6G transmission procedure may be different from the 5G transmission procedure. For example, different steps may be configured for the 6G transmission procedure and the 5G transmission procedure. For another example, different scrambling methods may be configured for the 6G transmission procedure and the 5G transmission procedure. This is not limited in this application.

One or more parameters in a set of configurations are related to the type of signals or channels. For example, configurations for CSI-RS may include one or more of: a first parameter #1 (e.g. a frequency domain allocation parameter), which may be used for determining the frequency resources of the first CSI-RS; a second parameter #1 (e.g. a nrofports parameter), which may be used for determining the number of antenna ports associated with the first CSI-RS resources; a third parameter #1 (e.g. a first OFDM symbol in a time domain parameter), which may indicate the first OFDM symbol in the PRB used for the first CSI-RS; a fourth parameter #1 (e.g. a cdm-type parameter), which may indicate the code division multiplexed (CDM) type; a fifth parameter #1 (e.g. a density parameter), which may indicate the density of the first CSI-RS resources measured in an RE, port or PRB; a sixth parameter #1 (e.g. a freqband parameter), which may indicate wideband or partial band of the first CSI-RS; and a seventh parameter #1 (e.g. a CSI-resource periodicity and offset parameter), which may indicate a periodicity and a corresponding offset for period or semi-persistent CSI resources, etc. For another example, configurations for SRS may include one or more of: a first parameter (e.g. nrofSRS-Ports), which may indicate the number of SRS ports; a second parameter (e.g. transmissionComb), which may indicate a comb value (2, 4 or 8) and a comb offset; a third parameter (e.g. resourceMapping), which may be used for determining the starting position in the time domain (e.g. field startPosition in the resourceMapping), the number of consecutive OFDM symbols (e.g. field nrofSymbols in the resourceMapping), and a repetition factor (e.g. field repetitionFactor in the resourceMapping); a fourth parameter (e.g. freqDomainPosition), which may indicate frequency domain locations for SRS; a fifth parameter (e.g. periodicityAndOffset), which may indicate a periodicity and a slot offset for the SRS resource; a sixth parameter (e.g. freqHopping), which may indicate the range of frequency hopping; and a seventh parameter (e.g. resourceType), which may indicate that the resource is periodic, semi-persistent or aperiodic, etc. This is not limited in this application.

The above embodiments describe possible sets of 6G configurations and sets of 5G configurations in a frequency domain, time domain, code domain, spatial domain and transmission procedure, respectively. The first set of configurations associated with the first mode may be any one of the above sets of 6G configurations, which includes part or all of the set of 5G configurations in the frequency domain, time domain, code domain, spatial domain or transmission procedure.

The first mode may be referred to as a 5G-like mode or a 5G-enhanced mode, which facilitates deep integration and collaboration of 5G and 6G. For example, physical resources associated with the first mode may overlap fully or partially with the 5G physical resources, e.g. as shown in FIGS. 10-12. The sequence associated with the first mode mapped in the overlapped physical resources may be the same as the 5G sequence, e.g. SSS, PSS, SRS, CSI-RS, PRACH etc. Alternatively, the sequence associated with the first mode mapped in the overlapped physical resources may be CDM with the 5G sequence, e.g. PRACH, DMRS, PUCCH, PRACH, etc. Detailed embodiments are given later in this application.

In some embodiments, multiple modes may further include a second mode, and a set of configurations associated with the second mode may be dedicated to the first radio access technology (e.g. 6G technology). The design of the dedicated set of configurations may not consider the impact of the co-existence between the 6G technology and the 5G technology. The second mode may be referred to as a 6G-pure mode. For example, the 6G-pure mode and the 5G-like mode may differ in one or more of: waveforms, coding schemes, access schemes, multi-antenna transmission schemes, scheduling schemes, physical channel structures, physical channel resource mapping, reference signal sequence generation schemes, reference signal physical resource mapping and so on. For example, the 6G-pure physical resources do not overlap with 5G physical resources. This is not limited in this application.

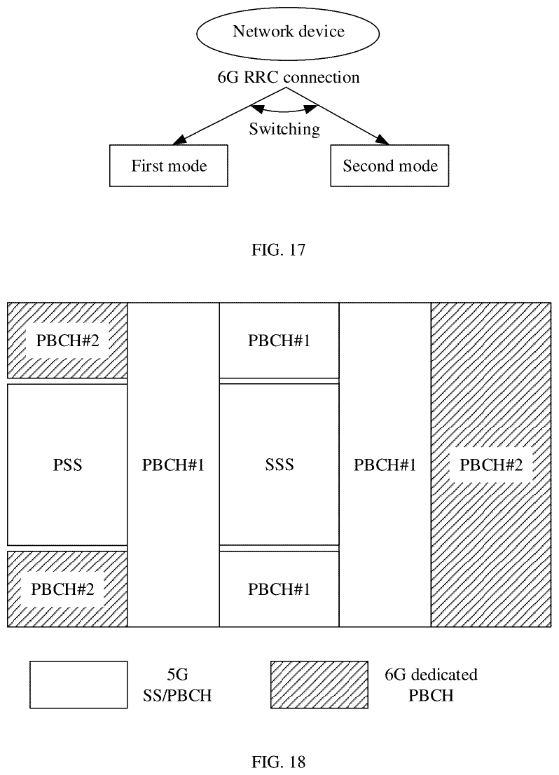

For example, FIG. 17 illustrates a schematic diagram of indicating a first mode or a second mode. The indication information may indicate the first mode or the second mode, and the first terminal device can work in the indicated mode. For example, the network device may establish RRC connection to a 6G UE in the DSS carrier, and could indicate the first mode and the second mode flexibly based on the co-existence requirement. When the co-existence requirement is needed, the network device could indicate the first mode (e.g. 5G-like mode or 5G-enhanced mode) for better co-existence. For example, 5G UE(s) and 6G UE(s) could share part or all of signals, that is, the part or all of signals can serve both 5G UE(s) and 6G UE(s), which can reduce overhead. When the co-existence requirement is not needed, the network device could indicate the second mode for better performance. The first mode and the second mode can be switched dynamically in the DSS, to achieve better co-existence efficiency.

Although not illustrated, three or more modes may be supported by the first terminal device. For example, the first terminal device may work in a 5G-like mode, 5G-enhanced mode or 6G-pure mode. When the first terminal device (e.g. a 6G UE) works in the 5G-like mode, the 6G UE may use physical resources that include all of the 5G physical resources, such as the 6G physical resources shown in FIG. 10. When the 6G UE may work in the 5G-enhanced mode, the 6G UE may use 6G physical resources that contain 5G physical resources or the 6G UE may use 6G physical resources that may be part of the 5G physical resources, as shown in FIG. 11 and FIG. 12. When the 6G UE may work in the 6G-pure mode, the 6G UE may use 6G physical resources that do not overlap with 5G physical resources. This is not limited in this application.

It should be noted that a mode may also be referred to as a type of air interface. For example, the 5G-like mode may be referred to as a 5G-like air interface, the 5G-enhanced mode may be referred to as a 5G-enhanced air interface and the 6G-pure mode may be referred to as a 6G-pure air interface. The 5G-like air interface may be similar to the 5G air interface, which is defined in 3^{rd} generation partnership project (3GPP) specification 38 series. The name is not limited in this application.

In some embodiments, a default mode (e.g. 5G-like mode, 5G-enhanced mode or 6G-pure mode) may be predefined. That is, the first terminal device could use a set of configurations associated with the default mode before the reception of indication information. When the first terminal device receives the indication information, the first terminal device could change (or switch) the set of configurations correspondingly. This is not limited in this application.

A set of 6G configurations may be for one or more of physical signals and physical channels. One type of physical signals or physical channels may correspond to two or more modes. For ease of understanding embodiments of this application, 5G-like, 5G-enhanced and 6G-pure configurations will be described in detail as examples.

When a set of configurations includes configurations for SSS and PSS, different modes may be associated with different configurations for the SSS and PSS.

For example, for the 5G-like mode, configurations for 5G-like SSS and PSS physical resources may be the same as 5G configurations. Optionally, configurations for 5G-like SSS and PSS sequence generation may be the same as 5G configurations. For example, the PSS sequence may be a freq domain-based pure BPSK M sequence and the SSS sequence may be a gold sequence. That is, a network device could generate an SSS sequence and a PSS sequence, and map the SSS sequence and the PSS sequence to physical resources. Both 5G UE(s) and 6G UE(s) could obtain the SSS and PSS from the physical resources. The network device could only transmit a set of SSS and PSS to serve both 5G UE(s) and 6G UE(s), and the resource utilization can be improved.

For example, for the 5G-enhanced mode, configurations for 5G-enhanced SSS and PSS physical resources may indicate a nested structure with the 5G SSS and PSS physical resources. Optionally, configurations for a 5G-enhanced SSS and PSS sequence may indicate a nested structure with the 5G SSS and PSS sequence. For example, the 5G SSS and PSS sequence and physical resources may be nested within the 5G-enhanced SSS and PSS sequence and physical resources. The length of the 5G SSS and PSS sequence is smaller than the length of the 5G-enhanced SSS and PSS sequence. The 5G-enhanced PSS and SSS can have better synchronization performance because of the longer sequence. For another example, the 5G-enhanced SSS and PSS sequence and physical resources may be nested within the 5G SSS and PSS sequence and physical resources. The size of the 5G SSS and PSS sequence is larger than the size of the 5G-enhanced SSS and PSS sequence. A 6G UE that receives the 5G-enhanced PSS and SSS can reduce power consumption because of the smaller physical resources.

For example, for the 6G-pure mode, configurations for 6G-pure SSS and PSS physical resources may be different from 5G configurations. Optionally, configurations for a 6G-pure SSS and PSS sequence may be different from 5G configurations. For example, the 6G-pure SSS and PSS physical resources may not overlap with the 5G SSS and PSS physical resources, e.g. FDM between the 6G-pure SSS and PSS. The 6G-pure SSS and PSS sequence and 5G SSS and PSS sequence may be generated in different ways. The configurations for 6G-pure SSS and PSS can be dedicated to the 6G technology, which makes the 6G UE(s) have better performance.

In some embodiments, a PBCH is transmitted along with the SSS and PSS, and the PBCH, SSS and PSS may be referred to as an SS/PBCH block. For the 5G-like or 5G-enhanced mode, part or all of 5G SSS and PSS can be shared by a 6G UE as described above. In some implementations, part or all of 5G PBCH may be shared by a 6G UE. For example, partial information in a 5G MIB (which is included in the 5G PBCH) may be shared by a 6G UE. The partial information may include one or more of: system frame number and CORESET0 configurations in MIB.

For example, FIG. 18 illustrates a schematic diagram of a 6G SS/PBCH block corresponding to a 5G-like mode. The 6G SS/PBCH block includes the 5G SS/PBCH block, and the SSS, PSS and at least part of the 5G PBCH are shared between 5G UE(s) and 6G UE(s). Optionally, a dedicated 6G PBCH (or dedicated 6G MIB) may be transmitted along with the shared SSS and PSS. For example, a dedicated 6G PBCH may be included in a 6G SS/PBCH. The dedicated 6G PBCH can be used for transmitting 6G dedicated information. The size and content of the dedicated 6G PBCH are not limited in this application. For example, a payload size of the dedicate 6G PBCH may be smaller than that of the 5G PBCH because partial information in the 5G MIB can serve both 5G UE(s) and 6G UE(s).

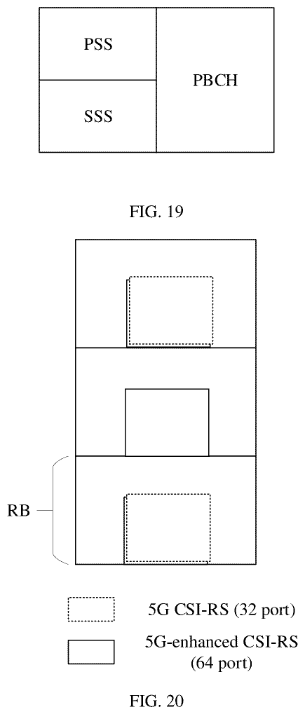

For example, FIG. 19 illustrates a schematic diagram of a 6G SS/PBCH block corresponding to a 6G-pure mode. The 6G-pure SS/PBCH block may be different from the 5G SS/PBCH block. For example, the PSS and SSS may be located in the same symbols, and the PBCH may be located after the PSS and SSS. This is not limited in this application.

Although not illustrated, a 5G-enhanced SS/PBCH block may include 5G-enhanced SSS and PSS, and the 5G-enhanced SSS and PSS may include 5G SSS and PSS and 6G dedicated SSS and PSS, as shown in FIG. 11. That is, the 5G-enhanced SSS and PSS could be longer than the 5G SSS and PSS, thereby, the 6G UE may get better performance compared to the 5G UE. Alternatively, the 5G-enhanced PSS and SSS are a subset of the 5G SSS and PSS, thereby, the 6G UE may save more power compared to the 5G UE.

When a set of configurations includes configurations for CSI-RS, different modes may be associated with different configurations for the CSI-RS.

For example, for a 5G-like mode, configurations for 5G-like CSI-RS physical resources may be the same as 5G configurations. Optionally, configurations for 5G-like CSI-RS sequence generation may be the same as 5G configurations. That is, a network device could generate a CSI-RS sequence, and map the CSI-RS sequence to physical resources. Both 5G UE(s) and 6G UE(s) could obtain the CSI-RS from the physical resources. The network device could only transmit a set of CSI-RS to serve both 5G UE(s) and 6G UE(s), and the resource utilization can be improved.

For a 5G-enhanced mode, configurations for 5G-enhanced CSI-RS physical resources may indicate a nested structure with the 5G CSI-RS physical resources.

For example, FIG. 20 illustrates a first schematic diagram of CSI-RS corresponding to a 5G-enhanced mode. 5G CSI-RS physical resources may be nested within 5G-enhanced CSI-RS physical resources. The 5G CSI-RS physical resources may correspond to 32 antenna ports, and 6G CSI-RS physical resources may correspond to the 32 antenna ports and other 32 antenna ports. That is, 64 ports CSI-RS may be supported by a 6G UE. The 5G-enhanced CSI-RS physical resources may be sparser than the 5G CSI-RS physical resources. Therefore, a 6G UE that receives the 5G-enhanced CSI-RS can have better performance for the more physical resources. For another implementation, the 5G-enhanced CSI-RS physical resources may be a subset of the 5G CSI-RS physical resources. A 6G UE that receives the 5G-enhanced CSI-RS can reduce power consumption because of the smaller physical resources.

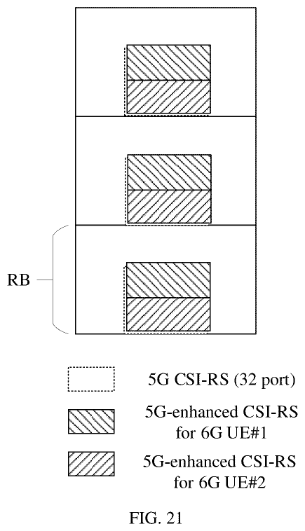

For example, FIG. 21 illustrates a second schematic diagram of CSI-RS corresponding to a 5G-enhanced mode. One or more 6G UEs may share 5G CSI-RS physical resources. For example, the 5G CSI-RS physical resources include a subset #1 and a subset #2, the subset #1 is shared between a 5G UE and a 6G UE #1, and the subset #2 is shared between the 5G UE and a 6G UE #2. More than one 6G UE can use a set of candidate 5G CSI-RS resources, and the sharing efficiency can be improved.

Optionally, a 5G-enhanced CSI-RS sequence could be CDM with a 5G CSI-RS sequence.

For example, for a 6G-pure mode, configurations for 6G-pure CSI-RS physical resources may be different from 5G configurations. Optionally, configurations for a 6G-pure CSI-RS sequence may be different from 5G configurations. For example, the 6G-pure CSI-RS physical resources may not overlap with the 5G CSI-RS physical resources. The 6G-pure CSI-RS sequence and 5G CSI-RS sequence may be generated in different ways. The configurations for 6G-pure CSI-RS can be dedicated to the 6G technology, which makes the 6G UE(s) have better performance.

When a set of configurations includes configurations for SRS, different modes may be associated with different configurations for the SRS.

For example, for a 5G-like mode, configurations for 5G-like SRS physical resources may be the same as 5G configurations. Optionally, configurations for 5G-like SRS sequence generation may be the same as 5G configurations. That is, both 5G UE(s) and 6G UE(s) could generate an SRS sequence, and map the SRS sequence to the same physical resources. The network device could obtain SRS for 5G UE(s) and 6G UE(s) from the same physical resources. The 5G UE(s) and 6G UE(s) may share the same physical resources for SRS, and the resource utilization can be improved.

For example, for a 5G-enhanced mode, configurations for 5G-enhanced SRS physical resources may indicate a nested structure with the 5G SRS physical resources. In an implementation, the 5G SRS physical resources may be nested within the 5G-enhanced SRS physical resources. Therefore, a 6G UE that receives the 5G-enhanced SRS can have better performance for the more physical resources. In another implementation, the 5G-enhanced SRS physical resources may be a subset of the 5G SRS physical resources. Optionally, the 5G-enhanced SRS physical resources may be non-uniform in the frequency domain. A 6G UE that receives the 5G-enhanced SRS can reduce power consumption because of the smaller physical resources.

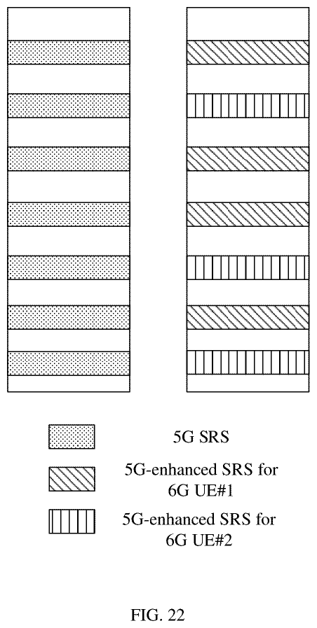

For example, FIG. 22 illustrates a schematic diagram of SRS corresponding to a 5G-enhanced mode. One or more 6G UEs may share 5G SRS physical resources. For example, the 5G SRS physical resources include a subset #1 and a subset #2, the subset #1 is shared between a 5G UE and a 6G UE #1, and the subset #2 is shared between the 5G UE and a 6G UE #2. More than one 6G UE can use a set of 5G SRS physical resources, and the sharing efficiency can be improved.

Optionally, a 5G-enhanced SRS sequence could be CDM with a 5G SRS sequence.

For example, for a 6G-pure mode, configurations for 6G-pure SRS physical resources may be different from 5G configurations. Optionally, configurations for a 6G-pure SRS sequence may be different from 5G configurations. For example, the 6G-pure SRS physical resources may not overlap with the 5G SRS physical resources. The 6G-pure SRS sequence and 5G SRS sequence may be generated in different ways. The configurations for 6G-pure SRS can be dedicated to the 6G technology, which makes the 6G UE(s) have better performance.

When a set of configurations includes configurations for demodulation reference signal (DMRS), different modes may be associated with different configurations for the DMRS. The DMRS may be uplink DMRS associated with a PUSCH, or the DMRS may be downlink DMRS associated with a PDSCH.

For a 5G-like mode, configurations for 5G-like DMRS physical resources may be the same as 5G configurations. Optionally, configurations for 5G-like DMRS sequence generation may be the same as 5G configurations. For example, the 5G-like DMRS may support type 1 configuration and type 2 configuration. The type 1 configuration may allocate every second resource element to DMRS in one symbol and support 6 DMRS ports. The type 2 may locate every third pair of resource elements to DMRS. That is, a network device could generate a PDSCH DMRS sequence, and map the PDSCH DMRS sequence to physical resources. Both 5G UE(s) and 6G UE(s) could obtain the PDSCH DMRS from the physical resources. The network device could only transmit a set of PDSCH DMRS to serve both 5G UE(s) and 6G UE(s), and the resource utilization can be improved.

For a 5G-enhanced mode, 5G-enhanced DMRS physical resources may be associated with more DMRS ports than 5G DMRS ports. For example, physical resources associated with a 5G DMRS port may be used for multiple 6G DMRS ports.

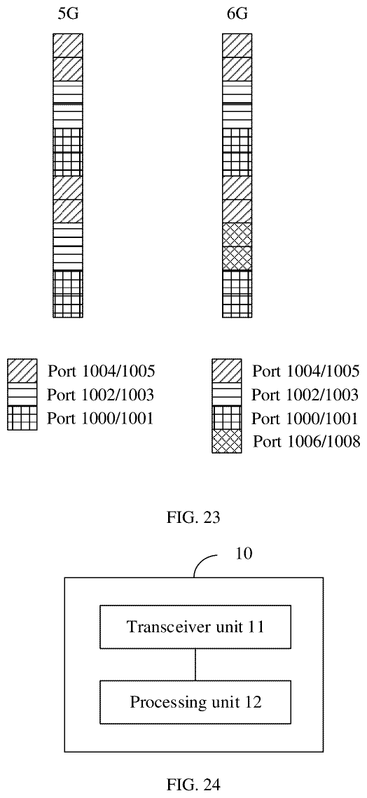

For example, FIG. 23 illustrates a schematic diagram of DMRS corresponding to a 5G-enhanced mode. As shown in FIG. 22, physical resources associated with a 5G DMRS port 1002/1003 may include a subset #1 and a subset #2, where the subset #1 may be associated with a 6G DMRS port 1002/1003 and the subset #2 may be associated with a 6G DMRS port 1006/1008. For 5G configurations, 4 REs in an RB are used for a 5G DMRS port. For 5G-enhanced configurations, 2 REs in an RB may be used for a 6G DMRS port. Therefore, in the same physical resources, 5G-enhanced configurations can support more DMRS ports (e.g. 8 ports) as compared to 5G configurations (e.g. 6 ports).

Optionally, for a 5G-like mode or 5G-enhanced mode, the configurations for DMRS may further support type 3 configuration and type 4 configuration. The type 3 configuration may allocate non-uniform resource elements to DMRS with average density d1 and the type 4 configuration may allocate non-uniform resource elements to DMRS with average density d2. The average density d1 is not equal to the average density d2, e.g. d1= 1/12, d2= 1/10. Candidate DMRS types may include {type 1, type 2, type 3, type 4}, where type 1 and type 2 configurations can be shared between the 5G UE(s) and 6G UE(s), and type 3 and type 4 configurations can be dedicated to the 6G UE(s).

For a 6G-pure mode, configurations for 6G-pure DMRS physical resources may be different from 5G configurations. Optionally, configurations for a 6G-pure DMRS sequence may be different from 5G configurations. For example, the 6G-pure DMRS physical resources may not overlap with the 5G DMRS physical resources. The 6G-pure DMRS sequence and 5G DMRS sequence may be generated in different ways. For example, candidate 6G-pure DMRS types may include {type 3, and type 4}. The configurations for 6G-pure DMRS can be dedicated to the 6G technology, which makes the 6G UE(s) have better performance.

When a set of configurations includes configurations for single user MIMO (SU-MIMO), different modes may be associated with different configurations for the SU-MIMO.

For example, for a 5G-like mode, the maximum support layers for a 6G UE may be equal to 8. For a 5G-enhanced mode, the maximum support layers for a 6G UE may be larger than 8, for example, a 6G UE may support 3 TBs, where each TB may support 4 layer transmission. For a 6G-pure mode, a 6G UE may support 2 TBs, where each TB may support more than 4 layer transmission. This is not limited in this application.

When a set of configurations includes configurations for multi-user, multiple-input, multiple-output technology (MU-MIMO), different modes may be associated with different configurations for the MU-MIMO.

For example, for a 5G-like mode, the maximum total layers of MU-MIMO UEs may be equal to N (N=24 or 48). For a 5G-enhanced mode or 6G-pure mode, the maximum total layers of the MU-MIMO UEs may be larger than N (e.g. 96 or 72). This is not limited in this application.

When the MU-MIMO technology is applied to one or more 6G UEs and one or more 5G UEs, the 6G UEs and the 5G UEs may form a MU-MIMO group. A UE in the MU-MIMO group may be configured with multiple CDM groups, where parameter(s) for determining the time-frequency resources and parameter(s) for generating the DMRS sequence may be associated with the CDM groups. For example, DMRS obtained from configurations within the same CDM group may be code division multiplexed. DMRS obtained from configurations in different CDM groups may be frequency division multiplexed. In other words, the DMRS obtained from the configurations within the same CDM group may share the same time-frequency resources. Time-frequency resources associated with the configurations in different CDM groups may not overlap. 5G UE(s) and 6G UE(s) may use the same CDM group for DMRS. Alternatively, 5G UE(s) and 6G UE(s) may use the different CDM groups for DMRS.

When a set of configurations includes configurations for a control resource set (CORESET), different modes may be associated with different configurations for the CORESET.

Optionally, the CORESET indicates physical resources used for control information or control channel(s), e.g. PDCCH. The CORESET may be CORESET0, which could be used for transmitting a PDCCH for system information block 1 (SIB1) scheduling.

For a 5G-like mode or 5G-enhanced mode, configurations for a 6G CORESET (5G-like CORESET or 5G-enhanced CORESET) may include part or all of configurations for a 5G CORESET (e.g. frequency/time resource allocation). That is, at least part of the physical resources of the 5G CORESET can be shared by a 6G UE. The 6G UE may use the unused physical resources in the 5G CORESET for PDCCH reception, e.g. PDCCH for SIB1 transmission. For example, the network device may indicate the unused physical resources (e.g. rate matching CCE index(es)) to the 6G UE dynamically.

In this embodiment, the unused physical resources in the 5G CORESET can be not wasted because of being used by the 6G UE, and the finer rate matching pattern can improve spectrum utilization efficiency.

Optionally, for 5G-like CORESET0 or 5G-enhanced CORESET0, a set of parameters associated with the 5G-like CORESET0 or 5G-enhanced CORESET0 may be the same as 5G CORESET0. The set of parameters may indicate one or more of a CCE structure, a CCE interleaving method, a candidate aggregation level and PDCCH candidates. For example, the set of parameters may include one or more of: interleaving, a resource element group (REG) bundle size, an inter-leaver size, a shift, a cyclic prefix and precoding. The set of parameters can be indicated to a 6G UE or predefined in the 6G UE, and this is not limited in this application.

For a 6G-pure mode, configurations for 6G-pure CORESET0 may be different from 5G configurations. For example, the 6G-pure CORESET0 may not overlap with the 5G CORESET0. The configurations for 6G-pure CORESET0 can be dedicated to the 6G technology, which makes the 6G UE(s) have better performance.

When a set of configurations includes configurations for a PDCCH structure, different modes may be associated with different configurations for the PDCCH structure.

For a 5G-like mode or 5G-enhanced mode, a 6G PDCCH structure (5G-like PDCCH structure or 5G-enhanced PDCCH structure) may be same as a 5G PDCCH structure. For example, a PDCCH may include multiple control channel elements (CCEs), and the number of CCEs is the aggregation level of the PDCCH. A CCE may correspond to 6 resource element groups (REGs), and a REG contains 1 PRB (i.e. 12 consecutive resource elements) in the frequency domain and 1 OFDM symbol in the time domain.

For a 6G-pure mode, configurations for a 6G-pure PDCCH structure may be different from 5G configurations. For example, a PDCCH may include multiple CCEs, and a CCE may correspond to one or more REGs, where the number of one or more REGs may be not equal to 6.

When a set of configurations includes configurations for a PUCCH, different modes may be associated with different configurations for the PUCCH.

For a 5G-like mode or 5G-enhanced mode, configurations for a 6G PUCCH (5G-like PUCCH or 5G-enhanced PUCCH) may include part or all of configurations for a 5G PUCCH (e.g. frequency-time resources). For example, at least part of the physical resources of the 5G PUCCH can be shared by a 6G UE. 5G UE(s) and 6G UE(s) could map the 5G PUCCH and 6G PUCCH to the same physical resources, and the resource utilization can be improved.

The 5G PUCCH and the 6G PUCCH that are mapped in the same physical resources can be CDM. For example, configurations for a PUCCH may include PUCCH format 0 and PUCCH format 1, where the PUCCH format 0 and PUCCH format 1 are shared between the 5G PUCCH and the 6G PUCCH. The network device could indicate the 6G UE to use unused (i.e. not used by the 5G UE) code-domain resources of the PUCCH format 0 or format 1.

Optionally, configurations for a PUCCH may further include PUCCH format 2 and PUCCH format 3, and the PUCCH format 2 and PUCCH format 3 may be dedicated to the 6G UE(s). That is, candidate PUCCH formats may include {format 1, format 2, format 3, format 4}, where format 1 and format 2 configurations can be shared between the 5G UE(s) and 6G UE(s), and format 3 and format 4 configurations can be dedicated to the 6G UE(s).

For a 6G-pure mode, configurations for a 6G-pure PUCCH may be different from 5G configurations. For example, 6G-pure PUCCH physical resources may not overlap with 5G PUCCH physical resources. For example, candidate 6G-pure PUCCH configurations may include {format 3, and format 4}. The configurations for the 6G-pure PUCCH can be dedicated to the 6G technology, which makes the 6G UE(s) have better performance.

When a set of configurations includes configurations for a PRACH, different modes may be associated with different configurations for the PRACH.

For a 5G-like mode or 5G-enhanced mode, configurations for a 6G PRACH (5G-like PRACH or 5G-enhanced PRACH) may include part or all of configurations for a 5G PRACH (e.g. frequency/time/code resource allocation).

In a first implementation, 5G PRACH time-frequency resources may be a subset of 6G PRACH time-frequency resources, and a 5G PRACH preamble may be a subset of a 6G PRACH preamble. For example, the length of the 5G PRACH preamble may be equal to K, and the length of the 6G PRACH preamble may be equal to K+L, where K and M are positive integers. Therefore, the 6G UE can have better performance for the long preamble.

In a second implementation, the 6G PRACH time-frequency resources may be a subset of the 5G PRACH time-frequency resources, and the 6G PRACH preamble may be a subset of the 5G PRACH preamble. Therefore, the 6G UE can save more power consumption for the short preamble.

In a third implementation, the 5G PRACH time-frequency resources and the 6G PRACH time-frequency resources may be the same, and the 5G PRACH preamble may be CDM with the 6G PRACH preamble. For example, the 5G preamble and the 6G preamble may be generated based on different logical root sequences.

In a fourth implementation, the 5G PRACH time-frequency resources and the 6G PRACH time-frequency resources may be the same, and a 5G PRACH procedure and a 6G PRACH procedure may use different scrambling methods. For example, the scrambling method may be used to determine an RNTI used for scrambling a message. The scrambled message may be message 3 with a 4-step RACH. Alternatively, the scrambled message may be message A with a 2-step RACH. The Msg 3 may be scrambled with a temporary cell (TC)-radio network temporary identifier (RNTI). A first value of the TC-RNTI associated with the 6G configuration and a second value of the TC-RNTI associated with the 5G configuration may be different. Alternatively, the Msg A may be scrambled with a radio access (RA)-RNTI. A first value of the RA-RNTI associated with the 6G configuration and a second value of the RA-RNTI associated with the 5G configuration may be different.

For a 6G-pure mode, configurations for a 6G-pure PRACH may be different from 5G configurations. For example, 6G-pure PRACH resources may not overlap with 5G PRACH resources. The configurations for 6G-pure CORESET0 can be dedicated to the 6G technology, which makes the 6G UE(s) have better performance.

The above embodiments are only for illustrative purposes. The above embodiments can be implemented together or they can be implemented individually. For example, some signals or channels may support three types of modes, but some signals or channels may not support them. This is not limited in this application.

The network device can indicate a mode in a variety of ways.

In some embodiments, the first indication information may indicate a mode explicitly. For example, when the first indication information indicates a mode among three modes, the size of the first indication information may be two bits. Value “00” may indicate the 5G-like mode, value “01” may indicate the 5G-enhanced mode and value “10” may indicate the 6G-pure mode. For example, when the first indication information indicates a mode among two modes, the size of the first indication information may be 1 bit. Value “o” may indicate the 5G-like mode and value “1” may indicate the 6G-pure mode. The terminal device may activate the indicated mode based on the first indication information. This is not limited in this application.

In some embodiments, a mode may be associated with a frequency band. Thereby, the network device could indicate a mode by indicating a frequency band. For example, the first mode (5G-like mode or 5-G enhanced mode) may be associated with a frequency band associated with the first radio access technology and the second radio access technology (e.g. 5G and 6G). The second mode may be associated with a frequency band dedicated to the first radio access technology. The association relationship may be predefined. For ease of understanding of embodiments of this application, an example of the association relationship between modes and frequency bands is given in Table 1.

TABLE 1

| Frequency band | Mode |
|---|---|
| DSS band (e.g. 3.5G) | 5G-like, 6G-pure mode, |
| | 5G-enhanced mode (optional) |
| 6G dedicated band | 6G-pure mode |
| (e.g. 10G) | |

For example, when a 6G dedicated band is non-overlapped with a 5G band, the network device may indicate a 6G UE to use the 6G dedicated BWP, where the 6G UE may further determine to activate the 6G-pure mode.

In some embodiments, during the initial access, a 6G UE could detect which mode is indicated. For example, the 6G UE could detect an SS/PBCH block, and determine whether the detected SS/PBCH block is a 5G-like SS/PBCH block, 5G-enhanced SS/PBCH block or 6G-pure SS/PBCH block. Thereby, the 6G UE could activate the mode corresponding to the detected SS/PBCH block.

The network device may transmit the first indication information in a variety of ways. For example, the network device may indicate a mode dynamically or not.

In some embodiments, the network device may indicate a mode semi-statically. The first indication information may be a semi-static indication. For example, a mode is associated with a frequency band (e.g. BWP), and the mode may be a profile of a BWP. By BWP switching, the mode can be switched. Optionally, the network device may indicate a mode by RRC signaling or MAC-CE signaling. The first indication information may be in an RRC message or a MAC-CE.

In some embodiments, the network device may indicate a mode dynamically. The first indication information may be a dynamic indication. For example, the network device may transmit DCI, where DCI includes the first indication information. The DCI may include a one or two-bit indicator to indicate a mode among two or more modes. The DCI may be UE-specific, group common DCI or broadcast DCI. This is not limited in this application.

The first indication information may indicate the first terminal device to switch from one mode to another mode. When the previous mode is a power saving mode (e.g. sleep state, idle state or inactive state), the first indication information may be included in wake-up signals, DCI or a paging message.

In some embodiments, a mode may be set with a corresponding timer. When the timer expires, the first terminal device may inactivate the corresponding mode. Optionally, the first terminal device may switch to a default mode.

For 6G UE(s), the network device may indicate the 6G UE(s) to use unoccupied resources of a control resource set for PDSCH transmission. That is, the network device and the first terminal device may perform the following step 930.

Optionally, at S930, the network device transmits second indication information to the first terminal device. Correspondingly, the first terminal device receives the second indication information from the network device.

The second indication information indicates one or more first resource units, the one or more first resource units are located in a first CORESET, and the one or more first resource units are used for a PDSCH. Unused control resources can be used for data transmission, and the resource utilization can be improved.

The first CORESET may be a 5G CORESET and/or 6G CORESET (5G-like CORESET, 5G-enhanced CORESET or 6G-pure CORESET).

The granularity of the first resource units is not limited in this application. For example, a first resource unit may be any one of: a resource block (RB), a control channel element (CCE) and a resource element (RE).

As described above, a 6G UE may be configured with a set of configurations associated with the 5G-like mode, 5G-enhanced mode or 6G-pure mode. The set of configurations may include one or more of: RRC configurations, MAC layer configurations, physical layer configurations and predefined configurations. This is related to the type of the signals or channels, and the type of the indicated mode. When part or all of the set of configurations are given by RRC configurations, MAC layer configurations or physical layer configurations, the network device and the first terminal device may perform step 940 before step 920.

Optionally, at S940, the network device transmits third indication information to the first terminal device. Correspondingly, the first terminal device receives the third indication information from the network device.

The third indication information could be used for determining the set of configurations associated with the indicated mode.

In some embodiments, candidate sets of configurations associated with the two or more modes may be predefined. Therefore, the first terminal device could determine to use which set of configurations based on the indicated mode. Optionally, when multiple candidate sets of configurations are associated with a mode, the network device may further indicate the specific set of configurations by the third indication information. Configurations for DMRS are taken as an example for ease of understanding. Candidate DMRS types may include {type 1, type 2, type 3, type 4} for the 5G-like mode or 5G-enhanced mode, and candidate DMRS types may include {type 3, type 4} for the 6G-pure mode. The network device may indicate the specific set of configurations by 2 bits when the 5G-like mode or 5G-enhanced mode is indicated. The network device may indicate the specific set of configurations by 1 bit when the 6G-pure mode is indicated. This is not limited in this application.

In some embodiments, one or more candidate sets configurations may be predefined, and additional configurations may be given by the third indication information when the set of configurations associated with the indicated mode is not predefined. For example, 5G-like configurations may be predefined, and the third indication information may indicate 5G-enhanced configurations or 6G-pure configurations corresponding to the indicated mode. In these embodiments, optionally, the third indication information may indicate one or more offsets between the predefined configurations and the 5G-enhanced or 6G-pure configurations corresponding to the indicated mode. Configurations for a CORESET are taken as an example for ease of understanding. A 5G-enhanced CORESET may be a subset of a 5G CORESET, a 5G-like CORESET is the same as the 5G CORESET and predefined, and the third indication information may indicate the one or more offsets between the 5G-enhanced CORESET and the 5G-like CORESET. The one or more offsets may consume less communications resources.

Multiple indicating methods are given in the above embodiments. In some embodiments, processing of the set of configurations may be different for 5G UE(s) and 6G UE(s). This is related to the type of the signals or channels, and the type of the indicated mode. Configurations for SRS are taken as an example for ease of understanding. 5G SRS may be a subset of 5G-enhanced SRS, and the 5G-enhanced SRS and the 5G SRS may be both periodic signals (as shown in FIG. 15). A counter nSRS, which counts the SRS transmissions in the 5G technology, may be calculated by different methods for the 6G technology, because the position of the SRS in the frequency domain is determined based on the counter. For example, the counter of the shared part could be the same as the counter of the 5G SRS resource respectively. The counters of the 6G SRS are determined based on the periodicity and timing offset of the 6G SRS resource, i.e. counting the SRS transmissions, and the counters of the shared part are replaced with the counters of the 5G SRS resource respectively (illustrated as a first way). Alternatively, the counters of the shared part may be determined based on the periodicity and timing offset of the 5G SRS resource, i.e. the same as the counters of the 5G SRS resource. The counters of the dedicated part may be determined based on the counters of the shared part, e.g. the counters of the shared part and the counter of the dedicated part may be different (illustrated as a second way). This is not limited in this application.

In embodiments of this application, at least part of a set of configurations could be shared between terminal device(s) associated with the first radio access technology and terminal device(s) associated with the second radio access technology. The network device could serve multiple terminal devices associated with different generations of technology with the same configurations. The multiple terminal devices associated with different generations of technology may co-exist better.

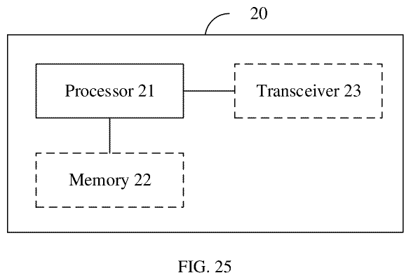

The methods according to embodiments of this application are described above in detail with reference to FIGS. 9-23. The apparatuses provided in embodiments of this application are described below in detail with reference to FIGS. 24-25. The description of apparatus embodiments corresponds to the description of the method embodiments. Therefore, for content that is not described in detail, refer to the foregoing method embodiments. For brevity, details are not described herein again.

Referring to FIG. 24, a schematic block diagram of a communication apparatus according to an embodiment of this application is shown. The communication apparatus 10 includes a transceiver unit 11 and a processing unit 12. The transceiver unit 11 may implement a corresponding communication function, and the processing unit 11 is configured to perform data processing. The transceiver unit 11 may also be referred to as a communication interface or a communication unit.

In some embodiments, the communication apparatus 10 may further include a storage unit. The storage unit may be configured to store instructions and/or data. The processing unit 12 may read instructions and/or data in the storage unit, to enable the communication apparatus to implement the foregoing method embodiments.

The communication apparatus 10 may be configured to perform actions performed by the first terminal device in the foregoing method embodiments. In this case, the communication apparatus 10 may be the first terminal device or a component that can be configured in the first terminal device. The transceiver unit 11 is configured to perform communicating-related (e.g., receiving/transmitting-related) operations on the first terminal device side in the foregoing method embodiments. The processing unit 12 is configured to perform processing-related operations on the first terminal device side in the foregoing method embodiments.

The communication apparatus 10 may implement steps or procedures performed by the first terminal device in FIGS. 9-23 according to embodiments of this application. The communication apparatus 10 may include units configured to perform the method performed by the first terminal device in FIGS. 9-23. In addition, the units in the communication apparatus 10 and the foregoing other operations and/or functions are separately used to implement corresponding procedures in FIGS. 9-23.

Alternatively, the communication apparatus 10 may be configured to perform actions performed by the network device in the foregoing method embodiments. In this case, the communication apparatus 10 may be the network device or a component that can be configured in the network device. The transceiver unit 11 is configured to perform communicating-related (e.g., receiving/transmitting-related) operations on the network device side in the foregoing method embodiments. The processing unit 12 is configured to perform processing-related operations on the network device side in the foregoing method embodiments.

The communication apparatus 10 may implement steps or procedures performed by the network device in FIGS. 9-23 according to embodiments of this application. The communication apparatus 10 may include units configured to perform the method performed by the network device in FIGS. 9-23. In addition, the units in the communication apparatus 10 and the foregoing other operations and/or functions are separately used to implement corresponding procedures in FIGS. 9-23.

A specific process in which the units perform the foregoing corresponding steps is described in detail in the foregoing method embodiments. For brevity, details are not described herein again.

Referring to FIG. 25, a schematic block diagram of another communication apparatus according to an embodiment of this application is shown. The communication apparatus 20 includes a processor 21. The processor 21 is coupled to a memory 22. The memory 22 is configured to store a computer program or instructions and/or data. The processor 21 is configured to execute the computer program or instructions and/or data stored in the memory 22, so that the methods in the foregoing method embodiments are executed.

In some embodiments, the communication apparatus 20 includes one or more processors 21.

In an example, as shown in FIG. 25, the communication apparatus 20 may further include the memory 22.

In some embodiments, the communication apparatus 20 may include one or more memories 22.

In an example, the memory 22 may be integrated with the processor 21, or disposed separately from the processor 21.

In an example, as shown in FIG. 25, the communication apparatus 20 may further include a transceiver 23, where the transceiver 23 is configured to receive and/or transmit a signal. For example, the processor 21 may be configured to control the transceiver 23 to receive and/or transmit a signal.

In some embodiments, the communication apparatus 20 may be a first terminal device or a component (e.g., a chip, a circuit, or a processing system) that can be configured in the first terminal device; or the communication apparatus 20 may be a network device or a component (e.g., a chip, a circuit, or a processing system) that can be configured in the network device.

In a solution, the communication apparatus 20 is configured to perform the operations performed by the first terminal device in the foregoing method embodiments.

For example, the processor 21 may be configured to perform a processing-related operation performed by the first terminal device in the foregoing method embodiments, and the transceiver 23 may be configured to perform a communicating-related (e.g., receiving/transmitting-related) operation performed by the first terminal device in the foregoing method embodiments.

In another solution, the communication apparatus 20 is configured to perform the operations performed by the network device in the foregoing method embodiments.

For example, the processor 21 may be configured to perform a processing-related operation performed by the network device in the foregoing method embodiments, and the transceiver 23 may be configured to perform a communicating-related (e.g., receiving/transmitting-related) operation performed by the network device in the foregoing method embodiments.

An embodiment of this application further provides a computer-readable storage medium. The computer-readable storage medium stores computer instructions used to implement the method performed by the first terminal device or the method performed by the network device in the foregoing method embodiments.

For example, when the computer program is executed by a computer, the computer may be enabled to implement the method performed by the first terminal device or the method performed by the network device in the foregoing method embodiments.

An embodiment of this application further provides a computer program product including instructions. When the instructions are executed by a computer, the computer is enabled to implement the method performed by the first terminal device or the method performed by the network device in the foregoing method embodiments.

An embodiment of this application further provides a communication system. The communication system includes the first terminal device and the network device in the foregoing embodiments.

For explanations and beneficial effects of related content of any communication apparatus provided above, refer to a corresponding method embodiment provided above. Details are not described herein again.

The processor mentioned in embodiments of this application may be a central processing unit (CPU). The processor may further be another general-purpose processor, a digital signal processor (DSP), an application-specific integrated circuit (ASIC), a field programmable gate array (FPGA), or another programmable logic device, a discrete gate, a transistor logic device, a discrete hardware component, or the like. The general-purpose processor may be a microprocessor, or the processor may be any conventional processor or the like.

The memory mentioned in embodiments of this application may be a volatile memory or a non-volatile memory, or may include a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM). For example, the RAM may be used as an external cache. By way of example but not limitation, the RAM may include a plurality of forms such as the following: a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

It should be noted that when the processor is a general-purpose processor, a DSP, an ASIC, an FPGA, another programmable logic device, a discrete gate or a transistor logic device, or a discrete hardware component, the memory (storage module) may be integrated into the processor.

It should be further noted that the memory described in this specification is intended to include, but is not limited to, these memories and any other memory of a suitable type.

A person of ordinary skill in the art may be aware that, in combination with the examples described in embodiments disclosed in this specification, units and methods may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the protection scope of this application.

It should be noted that the term “receive” or “receiving” used herein may refer to receiving or otherwise obtaining from an element/component in same apparatus or from another device separate from the apparatus. Similarly, the term “transmit” or “transmitting” may refer to outputting or sending to/for an element/component in same apparatus or to/for another device separate from the apparatus. For example, any of the methods/procedures described herein may be performed by a chipset, in which case any sending or receiving steps may occur between elements of the chipset.

It may be clearly understood by a person skilled in the art that, for the purpose of convenient and brief description, for a detailed working process of the foregoing apparatus and unit, refer to a corresponding process in the foregoing method embodiment. Details are not described herein again.

In the several embodiments provided in this application, the disclosed apparatuses and methods may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic forms, mechanical forms, or other forms.

The units described as separate parts may or may not be physically separate, and parts displayed as units may or may not be physical units, may be located in one position, or may be distributed on a plurality of network units. Some or all of the units may be selected based on an actual requirement to implement the solutions provided in this application.

In addition, function units in embodiments of this application may be integrated into one unit, or each of the units may exist alone physically, or two or more units may be integrated into one unit.

All or some of the foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on the computer, the procedures or functions according to embodiments of this application are all or partially generated. The computer may be a general-purpose computer, a special-purpose computer, a computer network, or another programmable apparatus. For example, the computer may be a personal computer, a server, a network device, or the like. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, an SSD), or the like. For example, the usable medium may include but is not limited to any medium that can store program code, such as a USB flash drive, a removable hard disk, a ROM, a RAM, a magnetic disk, or an optical disc.

The foregoing description is merely a specific implementation of this application, but is not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims and the specification.

What is claimed is:

1. A method, applied to a first terminal device associated with a first radio access technology, the method comprising:
receiving first indication information, wherein the first indication information indicates a mode among multiple modes, the multiple modes comprise a first mode, and a first set of configurations associated with the first mode comprises part or all of a second set of configurations associated with a second radio access technology; and
communicating based on the first indication information.

2. The method according to claim 1, wherein the first set of configurations comprises configurations of one or more of: physical resources, sequence generation, or procedures.

3. The method according to claim 1, wherein the first mode is associated with a first frequency band, and the first frequency band is associated with the first radio access technology and the second radio access technology.

4. The method according to claim 1, wherein the first indication information indicates a frequency band, and the mode indicated by the first indication information is associated with the frequency band.

5. The method according to claim 2, wherein the physical resources comprise one or more of: physical resources mapped with physical signals or channels, or candidate physical resources configured for physical signals or channels.

6. The method according to claim 1, wherein first physical resources associated with the first set of configurations comprise part or all of second physical resources associated with the second set of configurations.

7. The method according to claim 6, wherein the first physical resources are a subset of the second physical resources, or the second physical resources are a subset of the first physical resources.

8. The method according to claim 2, wherein the configurations of the sequence generation indicate one or more codes used for physical signals or channels.

9. The method according to claim 1, wherein the multiple modes comprise a second mode, and a set of configurations associated with the second mode is dedicated to the first radio access technology.

10. The method according to claim 1, wherein the multiple modes comprise a third mode, and a third set of configurations associated with the third mode comprises part of the second set of configurations.

11. The method according to claim 1, further comprising:
receiving second indication information, wherein the second indication information indicates one or more resource elements for data communication, and the one or more resource elements are located in a control resource set.

12. The method according to claim 11, wherein the control resource set is associated with the second radio access technology.

13. The method according to claim 1, further comprising:
receiving third indication information, wherein the third indication information indicates a set of configurations associated with the mode indicated by the first indication information.

14. The method according to claim 1, wherein the first indication information further indicates the first terminal device to transition from a fourth mode, and power consumption corresponding to the fourth mode is lower than power consumption corresponding to the mode indicated by the first indication information.

15. A method, applied to a network device, the method comprising:
transmitting first indication information to a first terminal device associated with a first radio access technology, wherein the first indication information indicates a mode among multiple modes, the multiple modes comprise a first mode, and a first set of configurations associated with the first mode comprises part or all of a second set of configurations associated with a second radio access technology; and
communicating with the first terminal device based on the first indication information.

16. The method according to claim 15, wherein the first set of configurations comprises configurations of one or more of: physical resources, sequence generation, or procedures.

17. The method according to claim 15, wherein the first mode is associated with a first frequency band, and the first frequency band is associated with the first radio access technology and the second radio access technology.

18. The method according to claim 15, wherein the first indication information indicates a frequency band, and the mode indicated by the first indication information is associated with the frequency band.

19. The method according to claim 16, wherein the physical resources comprise one or more of: physical resources mapped with physical signals or channels, or candidate physical resources configured for physical signals or channels.

20. The method according claim 15, wherein first physical resources associated with the first set of configurations comprise part or all of second physical resources associated with the second set of configurations.

21. The method according to claim 20, wherein the first physical resources are a subset of the second physical resources, or the second physical resources are a subset of the first physical resources.

22. The method according to claim 16, wherein the configurations of the sequence generation indicate one or more codes used for physical signals or channels.

23. The method according to claim 15, wherein the multiple modes comprise a second mode, and a set of configurations associated with the second mode is dedicated to the first radio access technology.

24. The method according to claim 15, wherein the multiple modes comprise a third mode, and a third set of configurations associated with the third mode comprises part of the second set of configurations.

25. The method according to claim 15, further comprising:
transmitting second indication information, wherein the second indication information indicates one or more resource elements for data communication, and the one or more resource elements are located in a control resource set.

26. The method according to claim 25, wherein the control resource set is associated with the second radio access technology.

27. The method according to claim 15, further comprising:
transmitting third indication information, wherein the third indication information indicates a set of configurations associated with the mode indicated by the first indication information.

28. The method according to claim 15, wherein the first indication information further indicates the first terminal device to transition from a fourth mode, and power consumption corresponding to the fourth mode is lower than power consumption corresponding to the mode indicated by the first indication information.

29. An apparatus, comprising:
at least one processor; and
memory storing one or more instructions that are capable of being run on the processor, and wherein when the one or more instructions are run, the apparatus is enabled to cause a first terminal device associated with a first radio access technology to perform operations comprising:
receiving first indication information, wherein the first indication information indicates a mode among multiple modes, the multiple modes comprise a first mode, and a first set of configurations associated with the first mode comprises part or all of a second set of configurations associated with a second radio access technology; and
communicating based on the first indication information.

30. A non-transitory computer-readable medium storing instructions, the instructions causing at least one processor in a device to cause a first terminal device associated with a first radio access technology to:
receive first indication information, wherein the first indication information indicates a mode among multiple modes, the multiple modes comprise a first mode, and a first set of configurations associated with the first mode comprises part or all of a second set of configurations associated with a second radio access technology; and
communicate based on the first indication information.
